(19) United States
(12) Patent Application Publication
(10) Pub. No.: US 2024/0410213 A1
(43) Pub. Date: Dec. 12, 2024

(54) Automatic Sliding Door Energy Redistributing Mechanism

(71) Applicant: Bill Schurtz, Austin, TX (US)

(72) Inventor: Bill Schurtz, Austin, TX (US)

(21) Appl. No.: 18/634,583

(22) Filed: Apr. 12, 2024

Related U.S. Application Data
(63) Continuation of application No. 29/929,373, filed on Feb. 21, 2024.
(60) Provisional application No. 63/506,423, filed on Jun. 6, 2023.

(51) Int. Cl. E05F 5/00

(52) U.S. Cl. CPC E05F 5/003

(57) ABSTRACT

Apparatus and associated methods relate to a sliding door closure system. The sliding door closure system includes a safety cushion mechanism configured to be suspended. The safety cushion mechanism may advantageously prevent injuries to a person's hands, feet, fingers, body parts and/or injury to pets. The sliding door closure system includes an anchor situated in a vertical closure track of a sliding door configured to be coupled to the suspension suspending the safety cushion mechanism. In a closure mode, the safety cushion mechanism may be displaced out of the vertical closure track of the sliding door so the sliding door may abut the vertical track frame. In a safety mode when the sliding door is closing, gravity urges the safety cushion mechanism into a position separating the sliding door from a frame so that the safety cushion mechanism absorbs the impulse of the sliding door.

### CROSS-REFERENCE TO RELATED APPLICATIONS

This application claims the benefit of U.S. Provisional Application Ser. No. 63/506,423, titled “Automatic Sliding Door Energy Redistribution,” filed by Bill Schurtz, on Jun. 6, 2023.

This application claims benefit of U.S. Design application Ser. No. 29/929,373, titled “Door Shock Absorber,” filed by Bill Schurtz, on Feb. 21, 2024.

This application incorporates the entire contents of the foregoing applications herein by reference.

### TECHNICAL FIELD

Various embodiments relate generally to door mechanics.

### BACKGROUND

Doors are crucial in architectural design, not only serving as entryways but also shaping the flow, privacy, and energy efficiency of spaces. Their design, from traditional wooden to modern glass styles, adds unique character and ambiance, influencing room perception, natural light, and security. Sliding doors, in particular, stand out for their space efficiency and seamless indoor-outdoor transitions, ideal for homes, hotels, and cruise ships where space optimization is key.

To enhance the functionality and longevity of sliding doors, incorporating cushioning materials into their mechanisms is a strategic approach. This involves using rubber or silicone bumpers, soft-close dampers, or cushioning strips along the track and frame. These elements are designed to absorb impact and reduce noise, ensuring a smooth, quiet operation. Rubber or silicone bumpers affixed to the door edge or frame, and cushioning strips along track edges, serve as soft buffers, protecting against hard contact and wear.

Door dampeners with cushioning features extend the life of doors and support a serene, secure atmosphere, essential in noise-sensitive environments such as offices, hospitals, and residential areas. By balancing functionality with design, these door dampeners underscore the doors' pivotal role in building design, ensuring comfort, safety, and aesthetic appeal in a cohesive, efficient manner.

### SUMMARY

Apparatus and associated methods relate to a sliding door closure system. In an illustrative example, the sliding door closure system includes a safety cushion mechanism configured to be suspended. The safety cushion mechanism may, for example, advantageously prevent injuries to a person's hands, feet, fingers, body parts and/or injury to pets. The sliding door closure system may, for example, includes an anchor situated in a vertical closure track of a sliding door configured to be coupled to the suspension suspending the safety cushion mechanism. In a closure mode, the safety cushion mechanism may, for example, be displaced out of the vertical closure track of the sliding door so the sliding door may abut the vertical track frame. For example, in a safety mode when the sliding door is closing, gravity may urge the safety cushion mechanism into a position separating the sliding door from a frame so that the safety cushion mechanism absorbs the impulse of the sliding door.

In illustrative embodiments, the safety cushion mechanism may be conical. The safety cushion mechanism may be spherical. The cushioning mechanism may, for example, include a conical shape with a predetermined width revolved along a longitudinal axis of the safety cushion mechanism. The cushioning mechanism may, for example, include a circular cross section. The predetermined with revolved along a longitudinal axis may, for example, advantageously disperse shock impulse from the moving sliding door. The cushion mechanism may, for example, include an axial-cross section. The safety cushion mechanism may, for example, include a container containing a plurality of smaller cushioning materials. The plurality of smaller cushioning material may, for example, advantageously enable customizable bags associated with the cushioning mechanism combined with multiple smaller foam pieces.

The suspension length may, for example, be configured to deploy the safety cushion mechanism into a placement between the sliding door and the frame along a first travel path across the vertical track. For example, the safety cushion mechanism may be configured (e.g., by suspension length, by cushion shape and/or fitment relative to a vertical track) such that the cushion swings into place and terminates its travel in a safety mode without oscillating into and out of the safety mode. Some embodiments may, for example, advantageously allow a safety deployment placement before the sliding door makes contact with the frame.

The anchor may, for example, be mounted to the vertical track. The anchor being mounted to the vertical track may, for example, advantageously allow the anchor to be securely affixed to the vertical track extending along the frame of the sliding door.

The safety cushion mechanism may, for example, be configured to act as a single pendulum. This may, for example, advantageously allow modeling of parameters associated with the length of the suspension, the anchor position, the resting position of the cushioning material in a safety mode, the equilibrium point of the safety cushioning mechanism.

The sliding door closure system may, for example, include a fastener releasably coupled to the anchor such that the suspension may be removed by removing the fastener. The suspension may, for example, be releasably coupled to the safety cushion mechanism. This may, for example, advantageously allow for the rapid installation and/or removal of the sliding door closure system.

The suspension may, for example, be affixed to the safety cushion mechanism. This may, for example, advantageously allow the safety transported as a unitary piece when installing and/or removing the system.

The details of various embodiments are set forth in the accompanying drawings and the description below. Other features and advantages will be apparent from the description and drawings, and from the claims.

### BRIEF DESCRIPTION OF THE DRAWINGS

FIG. 1A depicts an exemplary automatic sliding door energy redistributing mechanism (ERM) employed in an illustrative use-case scenario.

FIG. 1B depicts a front perspective view of an exemplary conical ERM.

FIG. 1C depicts a rear perspective view of the exemplary conical ERM.

FIG. 1D depicts a top view of the exemplary conical ERM.

FIG. 1E depicts a bottom view of the exemplary conical ERM.

FIG. 1F depicts a left side view of the exemplary conical ERM.

FIG. 1G depicts a right side view of the exemplary conical ERM.

FIG. 1H depicts a front side view of the exemplary conical ERM.

FIG. 1J depicts a back side view of the exemplary conical ERM.

FIG. 1I depicts an exemplary cross section and design drawing of the exemplary conical ERM.

FIG. 2A depicts an exemplary spherical ERM.

FIG. 2B depicts an exemplary circular ERM.

FIG. 2C depicts an exemplary conical ERM in an actuated mode.

FIG. 3A is an illustrative use-case scenario depicting an unactuated mode.

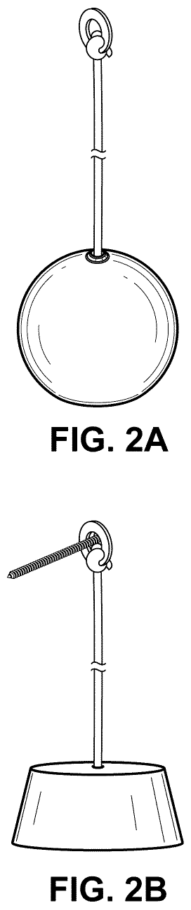

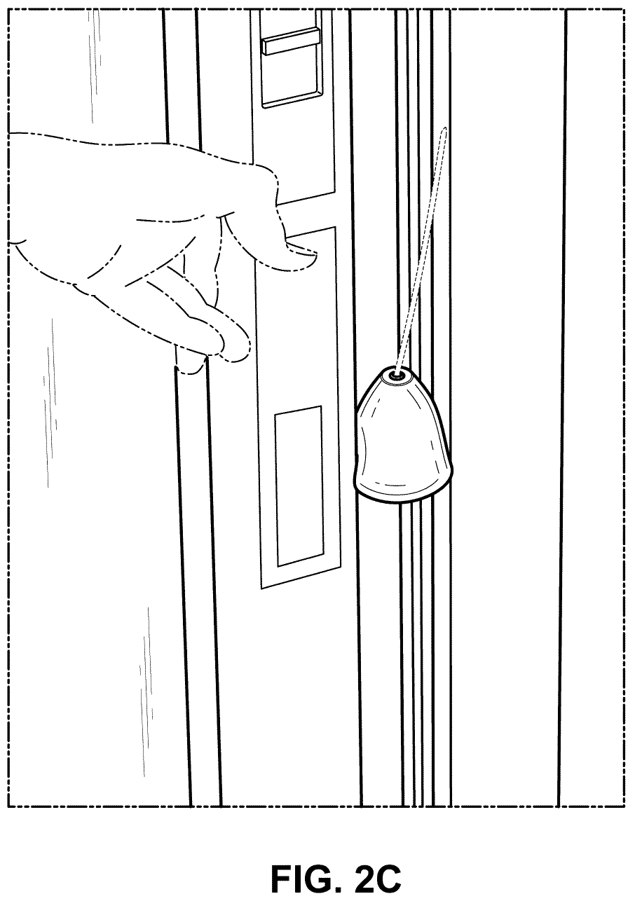

FIG. 2B is an illustrative use-case scenario depicting an actuated mode.

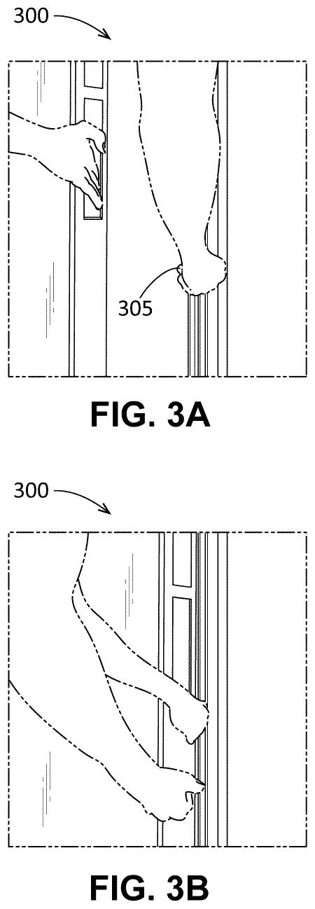

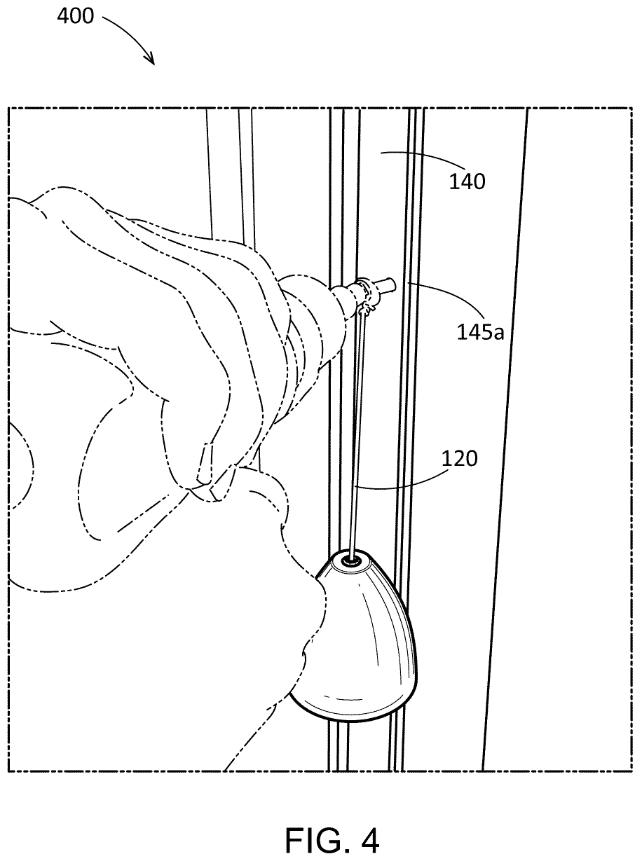

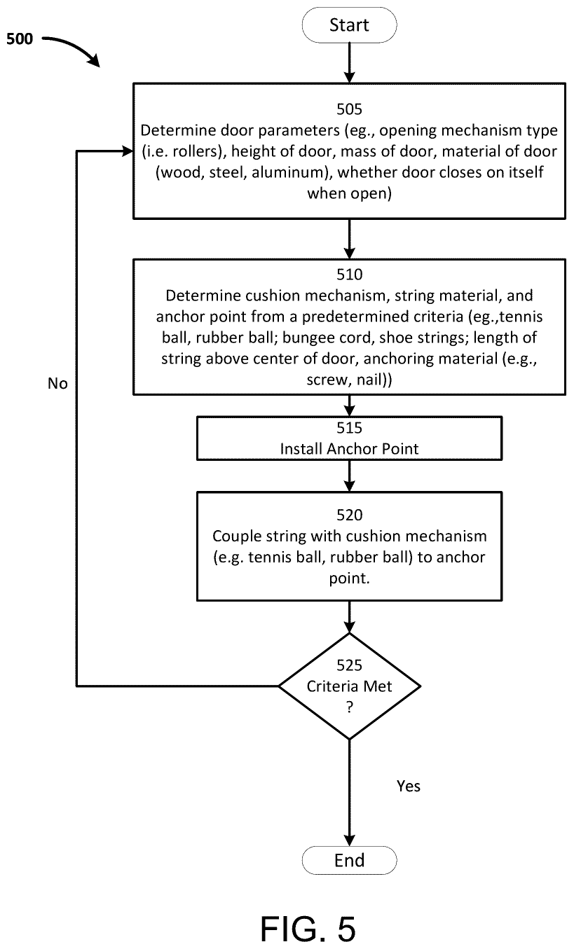

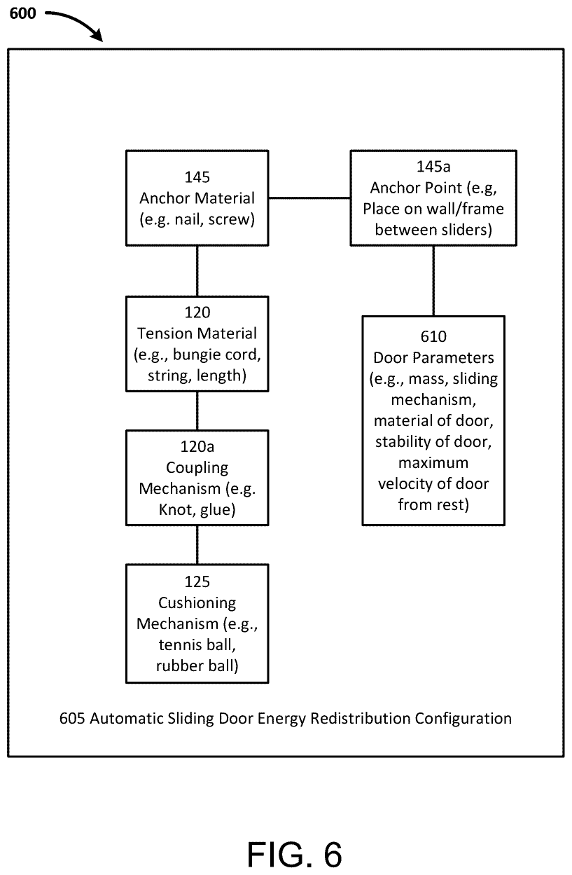

FIG. 3A depicts an exemplary scenario before a sliding door slides into a person's hand and/or finger.

FIG. 3B depicts an exemplary scenario after a sliding door slides into a person's hand and/or finger.

FIG. 4 depicts an exemplary installation of an ERM.

FIG. 5 depicts an exemplary method of installation.

FIG. 6 depicts an exemplary block diagram of manufacturing an exemplary ERM embodiment.

Like reference symbols in the various drawings indicate like elements.

### DETAILED DESCRIPTION OF ILLUSTRATIVE EMBODIMENTS

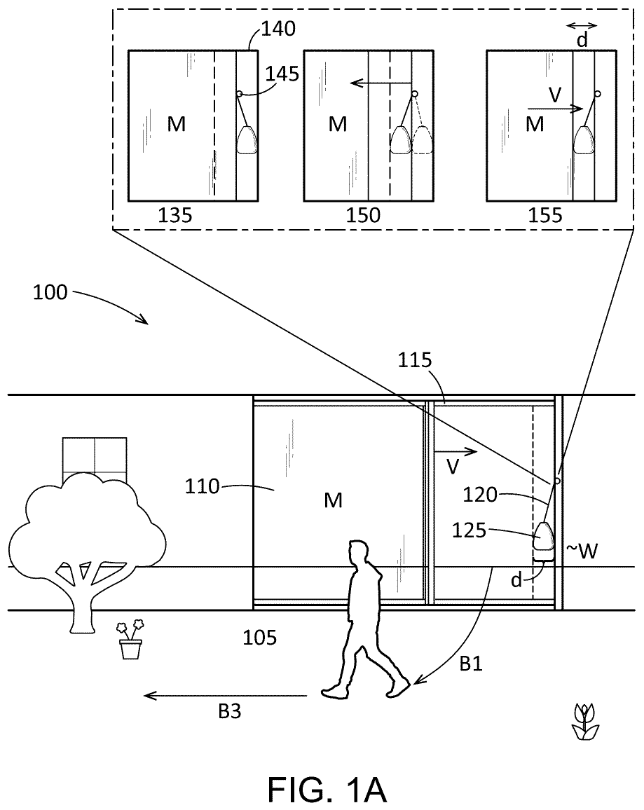

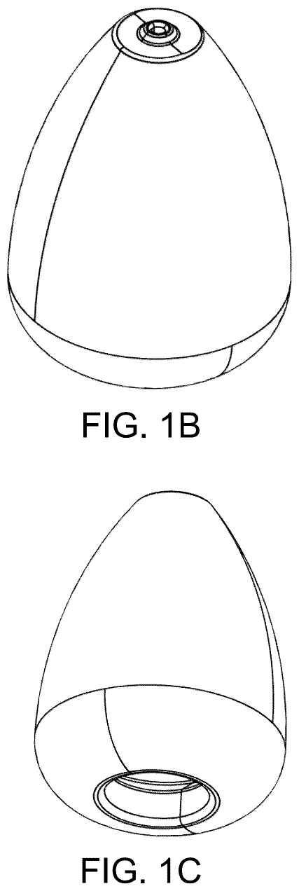

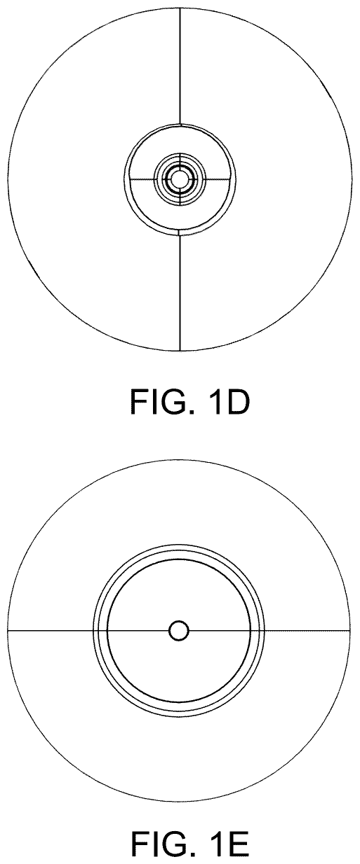

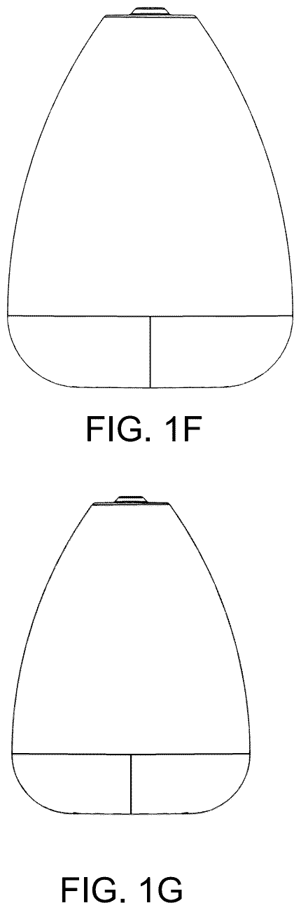

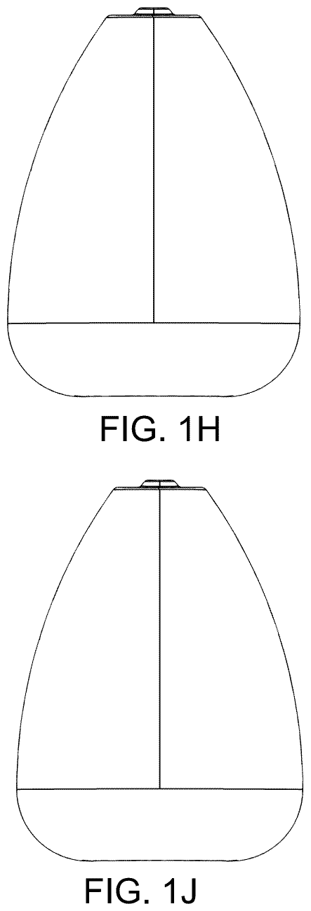

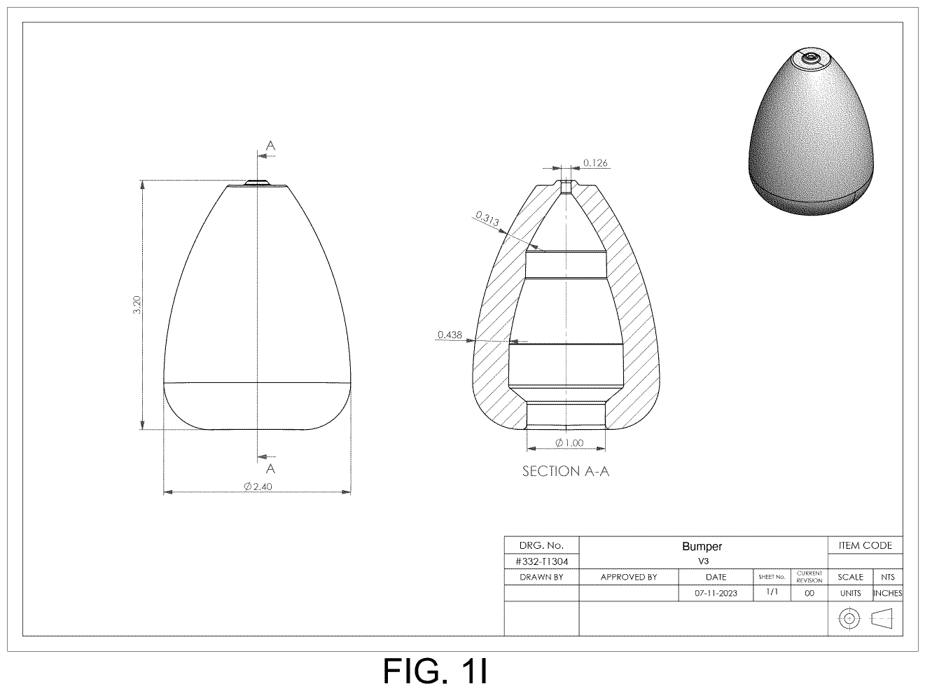

To aid understanding, this document is organized as follows. First, to help introduce discussion of various embodiments, an exemplary automatic sliding door energy redistributing mechanism (ERM) is introduced with reference to FIGS. 1A-1I. Third, a discussion an exemplary discussion of an injury scenario is discussed which the ERM may, for example, prevent. Fourth, involves of an installation description with reference to FIG. 4-5. Fifth, FIG. 6 depicts a method of manufacturing an ERM embodiment.

FIG. 1A depicts an exemplary automatic sliding door energy redistributing mechanism (ERM) employed in an illustrative use-case scenario 100. The ERM may, for example, include a sliding door closure safety cushion system.

The illustrative use-case scenario 100 includes a user 105. The illustrative use-case scenario 100 includes a sliding door 110. The sliding door 110 is coupled to a residence by a rail and track system 115. The illustrative use-case scenario 100 includes a tension material 120. The tension material may, for example, include a cord. The cord may, for example, include a bungie cord. The cord may, for example, include string. The tension material 120 is coupled to a cushioning mechanism 125.

The illustrative scenario 100 includes a close-up frame of an unactuated ERM 135 set up. The illustrative use-case scenario 100 includes a door frame 140. An anchor material 145 is fixedly coupled to the door frame 140. The anchor may, for example, be fixedly attached in same plane as the door. The anchor material may, for example, include a screw. The anchor material may, for example, include a nut and bolt. The anchor material may, for example, include a nail. The anchor material

The cushioning mechanism is in a position A, such that, the cushioning mechanism is displaced from its original resting place which lies between the door and the door frame. The door closure system includes a safety cushion suspended from an anchor in the center of a vertical closure track of a sliding door. When a sliding door is closed, the safety cushion is displaced out of the vertical closure track such that the door closes and latches against the vertical track frame.

The illustrative use-case scenario 100 includes an ERM in an actuated mode 150. The user 105 is walking has opened the door in motion B1. The cushion mechanism may, for example, include a safety cushion. The cushion mechanism may, for example, be of a rubber/silicon conical design. The cushion mechanism may, for example, include a tennis ball. The safety mechanism may, for example, include a rubber ball. When the sliding door is opened, gravity urges the safety cushion as a pendulum weight into the vertical closure track in the path of the sliding door.

The illustrative use-case scenario 100 includes an actuated crash mode 155 where the door crashes into the cushioning material. Accordingly, when the sliding door is closed again, the safety cushion is hanging between the sliding door and the vertical closure track, such that the safety cushion absorbs and disperses energy to reduce the momentum of the sliding door below a safe threshold of momentum. The safety cushion may, for example, stop the sliding door before it reaches the vertical closure track. Accordingly, the safety cushion prevents the sliding door from slamming a person's fingers between the sliding door and the vertical closure track of the door frame.

The cushion mechanism changes from its position A to position C in motion B2. Position C has a lower state of potential energy than position A, such that the potential energy differential converts into kinetic energy to move the ball to position C as depicted through an exemplary motion B2.

The cushioning mechanism has a diameter d. The cushioning mechanism may, for example, act as a spring to convert the door's energy as it closed into the frame. The cushioning mechanism may, for example, act as a dampener to the kinetic energy of the door as it moves toward the frame. A door frame of the sliding door includes a width “w”. A vertical track of the sliding door may, for example, be centered along the door frame to receive the sliding door as it closes.

The actuated crash mode 155 includes a cushioning phase 155a. The cushioning mechanism may, for example, act like a spring. The cushioning mechanism may, for example, act as a dampener. The cushioning mechanism may, for example, compress and elastically return to its original position after dissipating the kinetic energy. The actuate crash mode includes a rest stage 155b, where the door is pushed back from its position such that the cushioning mechanism may, for example, return to position C.

For example, the safety cushion may automatically swing into the path of a sliding door when it is opened and prevent a child (e.g., hands, fingers, body) from being slammed in the sliding door frame when it is suddenly slid closed against the door frame's vertical closure track, such as when they are trying to follow a parent through a door.

In some embodiments, the safety cushion may be a rubber ball suspended by a string from a fastener in the center of the vertical closure track. In some embodiments, the safety cushion may be at least partially hollow. In some embodiments, the safety cushion may be suspended by a spring member that urges the safety cushion into alignment between the sliding door and the vertical track of the door frame. In some embodiments, a pendulum length of the safety cushion may be below a predetermined maximum length so that the safety cushion settles into the door frame in time to prevent slamming of the sliding door.

In some embodiments, the safety cushion may be a rubber/silicon solid or hollow disk, rubber/silicon solid or hollow cone, suspended by a string/cord/ribbon/wire from a fastener in any part (top/middle/bottom) of the vertical closure track. The fastener can be attached using an existing screw in the sliding frame or a new screw can be secured to the vertical frame.

In some embodiments, a pendulum length may be greater than a predetermined minimum length such that the safety cushion may be manually displaced to either side of the door frame to allow closure and latching of the sliding door to the vertical track of the door frame.

The mass of the door may, for example, be 10 kg. The mass of the door may, for example, be 25 kg. The mass of the door may, for example, be 50 kg. The mass of the door may, for example, be 50 kg. The mass of the door may, for example, be 100 kg. The mass of the door may, for example, be 150 kg. The mass of the door may, for example, be 200 kg.

The door may, for example, weigh 50 lbs. The door may, for example, weigh 100 lbs. The door may, for example, weigh 150 lbs. The door may, for example, weigh 200 lbs. The door may, for example, weigh 300 lbs.

The length of the cord may, for example, include 2 inches. The length of the cord may, for example, include 5 inches. The length of the cord may, for example, affect the amount of time it takes to reach position C from Position A.

The door may, for example, close at 0.5 m/s. The door may, for example, close at 1 m/s. The door may, for example, close at 5 m/s. The door may, for example, close at 8 m/s. The kinetic energy may, for example, be the velocity of the door squared multiplied by the mass of the door.

The cushioning mechanism may, for example, prevent a child from losing a finger. The cushioning mechanism may, for example, prevent the door from shattering. The door may, for example, close when left unattended. The door may, for example, cause serious injuries to unexpecting persons attempting to leave the house as the door is closing without some cushioning mechanism.

In some embodiments, the ERM may, for example, include a circular cross-section. The ERM may, for example, be applicable to a mounted vertical track. The ERM may, for example, include a single pendulum as its cushioning mechanism.

In some embodiments, the ERM may, for example, require no additional hardware by using existing screws within the door frame.

The ERM may, for example, be advantageously used to protect small children. Doors may, for example, weigh over 300 pounds-force (lbs). and may, for example, reach velocities of at least 8 meters/second (m/s). The sliding doors without an ERM may, for example, act as a guillotine. The sliding doors without an ERM may, for example, cause injured hands, and/or amputations. Sliding doors may, for example, include any doors that slide. Doors may, for example, be used for residential purposes. Doors may, for example, be used for commercial purposes.

The ERM may, for example, force a user to stop and pull the ball out of the way when closing the door latching it in an unactuated mode. The ERM may, for example, prevent children rushing after their parents from amputating or injuring their hands when following their parents. The cushioning mechanism may, for example, be placed at the center of the frame and/or some predetermined distance from the center. Multiple ERMs may, for example, work in conjunction with each other to provide more cushioning.

An installation method may, for example, include unscrewing one screw in an existing door frame. The next step may, for example, include installing a washer at a preferred height. The string needs to be short enough to respond quickly to seat itself in its original resting position. Acceptable string lengths may, for example, vary from door to door.

FIGS. 1B-1J depict an exemplary conical cushioning mechanism. FIG. 1I provides illustrative dimensions of the conical cushioning mechanism. The conical cushioning mechanism may, for example, absorb the impulse when impacted by a sliding door. The conical cushioning mechanism may, for example, advantageously disperse the impulse such that the sliding door gently comes to a stop. Although illustrative dimensions of a particular embodiment are shown in FIG. 1I, other dimensions and proportions are contemplated. Some embodiments may, by way of example and not limitation, have dimensions determined by a target door and/or track. For example, different size doors and/or frames (e.g., tracks) may be fitted with different dimensions and/or proportions. FIG. 2A-2B demonstrate other contemplated embodiments, by way of example and not limitation.

FIG. 2A-2C depicts exemplary cushioning mechanism. FIG. 2A depicts a spherical cushioning mechanism. FIG. 2B depicts a puck cushioning mechanism. FIG. 2C depicts a cushioning mechanism resting between the sliding door and sliding door frame.

FIG. 3A-3B depicts an exemplary sliding door without an ERM. FIG. 3A depicts a person's body part in the path of a sliding door. FIG. 3B depicts an injury resultant from the sliding door without a device to slow down the impact of the sliding door. Exemplary scenario 300 includes a person's body part 305. The exemplary scenario 300 includes an injured human body part 310, which was the result of the door crashing into the human body part.

In some embodiments, an exemplary ERM may, for example, be conical. The exemplary ERM may, for example, be conical. The exemplary ADSERM may, for example, be cubical. The exemplary ASERM may, for example, be star shaped. The exemplary ASSDERM may, for example, be rectangular. The exemplary ERM may, for example, include irregular shapes.

The cord length may, for example, be 5 inches. The cord length may, for example, be 6 inches. The cord length may, for example, be 4 inches.

FIG. 4 depicts an exemplary installation 400 of an ERM. The anchor material 145 includes an anchor point 145a. The anchor point may, for example, be preinstalled on the door frame. The tension material 120 includes a coupling mechanism 120a such that the cord attaches to the ball and/or the anchor point.

FIG. 5 depicts an exemplary method 500 of installation. In step 505, a user of the method determines the door parameters. The door parameters may, for example, include an opening mechanism type. The opening mechanism type may, for example, be a sliding door that includes rollers. The user of the method determines the height of door. The user of the method may, for example, determine the mass of the door. The user of the method may, for example, determine the material type of the door (wood, steel, aluminum). The user of the method may, for example, determine whether the door closes on itself when open.

The user of the method may, for example, include a person. The user of the method may, for example, include groups of people. The user of the method may, for example, include users using machines. The user of the method may, for example, include users using software to determine whether the parameters meet certain predetermined criteria. Software may, for example, be employed to determine the predetermined criteria.

In step 510, the user of the method determines the cushioning mechanism, string material, and/or anchor point from a predetermined criterion. The cushion mechanism may, for example, be of a rubber/silicon conical design. The cushioning mechanism may, for example, include a tennis ball. The cushioning mechanism may, for example, include a rubber ball. The cord material may, for example, include a bungee cord. The parameters of the cord may, for example, include length. The cord material may, for example, include shoestrings. The cord parameters may, for example, include setting an anchor point a length of the cord above the center of mass of the sliding door. The anchor point parameters may, for example, anchor material. The anchor material may, for example, include a screw. The anchor material may, for example, include a nail. The anchor material may, for example, include a nut & bolt mechanism. The anchor material may, for example, include a washer.

In step 515, the user of the method installs the anchor point. In step 520, the user of the method couples the cord with the attached cushioning mechanism to the anchor point. In step 525, determine whether the predetermined criteria for an effective ERM is met. If yes, the method ends. If not, the user of the method returns to step 505 and proceeds through the steps iteratively.

For example, the method may include reevaluating whether the cushioning mechanism provides enough dampening to prevent the sliding door from slamming shut. For example, the method may include reevaluating the length of the string. For example, the method may include reevaluating the anchor point. For example, the method may include reevaluating the cord material. For example, the method may include re-measure the dimensions of the door. For example, the method may include measuring the weight of the door.

FIG. 6 depicts an exemplary block diagram 600 of an ERM. The block diagram 600 includes an exemplary automatic sliding door energy redistribution configuration 605.

The block diagram 600 includes a tension material 120. The tension material may, for example, be a string. The tension material may, for example, be a cord. The tension material may, for example, be a bungee cord. The tension material may, for example, include a predetermined length.

The block diagram 600 includes a coupling mechanism 120a. The coupling mechanism used to attach the ball to the string and/or cord to the door frame may, for example, be a knot. The coupling mechanism may, for example, be glue. The coupling mechanism may, for example, be a screw. The coupling mechanism may, for example, be nail. The coupling mechanism may, for example, be a nut and bolt.

The block diagram 600 includes a cushioning mechanism 125. The cushioning mechanism may, for example, include a cushion material. The cushion material may, for example, include a tennis ball. The cushion material may, for example, include a rubber ball.

The block diagram 600 includes an anchor material 145. The anchor material may, for example, be a screw. The anchor material may, for example, be a nail. The anchor material may, for example, be a nut and bolt. The anchor materials may, for example, include a washer.

The block diagram 600 includes an anchor point 145a. The anchor point may, for example, be a place on the wall and/or frame. The anchor point may, for example, be between the sliders.

The exemplary automatic sliding door energy redistribution configuration 605 includes door parameters 610. The door parameters may, for example, include the mass of the door. The door parameters may, for example, include the maximum velocity of the door from ordinary use. The door parameters may, for example, include the material for the door. The door parameters may, for example, include the stability of the door. the door parameter s may, for example, include the maximum velocity from rest.

Some embodiments may, for example, be configured to be equal to or less than the period of the closing door. Some embodiments may, for example, a deployment time based on the length of the suspension suspending a cushioning object of the ERM to match the duration from the closed position. The period of a pendulum may, for example, be determined by the following formula for a pendulum period: T(s)=2*pi*(g/L)\hat{ }2. Here, the cushioning mechanism may, for example, oscillate around the vertical equilibrium point at the center of the track. The cushioning mechanism may, for example, be stayed to rest by external forces, such as friction and air resistance at a point beneath the anchor along the vertical track. In some implementations, by way of example and not limitation, the deployment time may be determined by expected closing times and/or door operation times. In some embodiments, as an illustrative example, deployment time may be less than 5 seconds. In some implementations, deployment time may, for example, be less than or equal to 3 seconds. In some examples, deployment time may be less than or equal to 1 second.

Although various embodiments have been described with reference to the figures, other embodiments are possible.

Although an exemplary system has been described with reference to FIG. 1-6, other implementations may be deployed in other industrial, scientific, medical, commercial, and/or residential applications. The automatic sliding door energy redistributing mechanism (ERM) may, for example, be employed in preschools. The ERM may, for example, be implemented in cars with non-automatic sliders. The ERM may, for example, be implemented in day care centers. The ERMS may, for example, be implemented in kindergarten. The ERM may, for example, be implemented in middle schools. The ERM may, for example, be employed in cruise ships. The ERM may, for example, be employed in hotels. The ERM may, for example, be implemented in resorts.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A sliding door closure system comprising:
a safety cushion mechanism comprising a conical shape with a predetermined maximum width revolved along a longitudinal axis of the safety cushion mechanism.
a suspension configured to suspend the safety cushion mechanism in a pendulous orientation;
an anchor situated in a center of a vertical closure track of a sliding door, and configured to be coupled to and support the suspension suspending the safety cushion mechanism; and,
a sliding door,
wherein the safety cushion mechanism, the suspension, and the anchor are configured such that:
when the sliding door is closed, the safety cushion mechanism is selectably operated into a closure mode in which the safety cushion mechanism is displaced out of the vertical closure track of the sliding door so the sliding door may abut the vertical track frame, and
when the sliding door is closing, gravity urges the safety cushion mechanism into a safety mode in which the safety cushion mechanism is disposed in a position separating the sliding door from a frame so that the safety cushion mechanism absorbs and disperses energy of the sliding door.

2. The sliding door closure system of claim 1, wherein the safety cushion mechanism includes an axial-cross section.

3. The sliding door closure system of claim 1, wherein the safety cushion mechanism comprises a container containing a plurality of smaller cushioning materials.

4. The sliding door closure of claim 1, wherein a length of the suspension is configured to deploy the safety cushion mechanism into a placement between the sliding door and the frame at the termination of a first travel path across the vertical track.

5. The sliding door closure system of claim 1, wherein the safety cushion mechanism comprises a circular cross section.

6. The sliding door closure system of claim 1, wherein the anchor is mounted to the vertical track.

7. The sliding door closure system of claim 1, wherein the safety cushion mechanism is configured to act as a single pendulum.

8. The sliding door closure system of claim 1, further comprising a fastener releasably coupled to the anchor such that the suspension may be removed by removing the fastener.

9. The sliding door mechanism of claim 1, wherein the suspension is affixed to the safety cushion mechanism.

10. A sliding door closure system comprising:
a safety cushion mechanism;
a suspension configured to suspend the safety cushion mechanism;
an anchor situated in a vertical closure track of a sliding door, and configured to be coupled to and support the suspension suspending the safety cushion mechanism; and,
a sliding door,
wherein at least the safety cushion mechanism is configured such that:
when the sliding door is closed, the safety cushion mechanism is selectably operated into a closure mode in which the safety cushion is displaced out of the vertical closure track of the sliding door so the sliding door may abut the vertical track frame, and
when the sliding door is closing, gravity urges the safety cushion mechanism into a safety mode in which the safety cushion mechanism is disposed in a position separating the sliding door from a frame so that the safety cushion mechanism absorbs and disperses energy of the sliding door.

11. The sliding door closure system of claim 10, wherein the safety cushion mechanism comprises a conical shape with a predetermined width revolved along a longitudinal axis of the safety cushion mechanism.

12. The sliding door closure system of claim 10, wherein the cushion mechanism includes an axial-cross section.

13. The sliding door closure system of claim 10, wherein safety cushion mechanism comprises a container containing a plurality of smaller cushioning materials.

14. The sliding door closure of claim 10, wherein a length of the suspension is configured to deploy the safety cushion mechanism into a placement between the sliding door and the frame at the termination of a first travel path across the vertical track.

15. The sliding door closure system of claim 10, wherein the safety cushion mechanism further comprises a circular cross section.

16. The sliding door closure system of claim 10, wherein the anchor is mounted to the vertical track.

17. The sliding door closure system of claim 10, wherein the safety cushion mechanism is configured to act as a single pendulum.

18. The sliding door closure system of claim 10, further comprising a fastener releasably coupled to the anchor such that the suspension may be removed by removing the fastener.

19. The sliding door mechanism of claim 10, wherein the suspension is releasably coupled to the safety cushion mechanism.

20. The sliding door mechanism of claim 10, wherein the suspension is affixed to the safety cushion mechanism.
